(19) United States
(12) Patent Application Publication
(10) Pub. No.: US 2016/0078598 A1
(43) Pub. Date: Mar. 17, 2016

(54) IMAGE PROCESSOR AND IMAGE PROCESSING METHOD

(71) Applicant: KABUSHIKI KAISHA TOSHIBA, Tokyo (JP)

(72) Inventor: Yasuki TANABE, Yokohama Kanagawa (JP)

(21) Appl. No.: 14/645,170

(22) Filed: Mar. 11, 2015

(30) Foreign Application Priority Data
Sep. 12, 2014 (JP) 2014-186844

(51) Int. Cl. G06T 3/40; H04N 5/232; H04N 5/272; G06T 7/00; G06T 5/00

(52) U.S. Cl. CPC G06T 3/4007; G06T 3/4038; G06T 7/0081; G06T 5/002; H04N 5/272; H04N 5/23229; H04N 5/23216; G06T 2210/22; G06T 2200/24; G06T 2207/20144; G06T 2207/20221

(57) ABSTRACT

An image processor has an image acquisition unit to acquire a plurality of image data items obtained by imaging an identical subject, a distance estimator to estimate a distance from a reference position to predetermined pixels, a threshold value determining unit to determine a threshold value of the distance, a plurality of foreground/background separators to separate the common image in the image data items into the foreground image and the background image, a plurality of image clipping units to generate a partial background image, a plurality of image enlargers to generate an enlarged partial background image from the image data items, a occlusion interpolator to generate an interpolated occlusion image by interpolating lacking pixels, and a composite image generator to generate a composite image based on the foreground image and the interpolated occlusion image.

### CROSS REFERENCE TO RELATED APPLICATIONS

This application is based upon and claims the benefit of priority from the prior Japanese Patent Application No. 2014-186844, filed on Sep. 12, 2014, the entire contents of which are incorporated herein by reference.

### FIELD

One embodiment relates to an image processor and an image processing method.

### BACKGROUND

When shooting a subject in a more emphasized way, it is effective to shoot the subject using a telephoto lens with an enough distance between a camera and the subject to defocus the background image of the subject.

However, it may impossible to secure a sufficiently long distance from the camera to the subject, depending on the shooting environment. Further, it may impossible to shoot the subject together with a background image which is required to appear behind the subject, depending on the restrictions on the installation location of the camera.

### BRIEF DESCRIPTION OF THE DRAWINGS

FIG. 1 is a block diagram showing a schematic structure of an image processor 1 according to an embodiment.

FIG. 2 is a diagram explaining a second technique for determining a threshold value.

FIG. 3 is a diagram explaining a third technique for determining a threshold value.

FIG. 4 is a flow chart showing an example of the processing operation performed by each of a first foreground/background separator 6 and a second foreground/background separator 7.

FIGS. 5A, B, and C are diagrams each showing a concrete example of the clipping volume and clipping position determined by a first image clipping unit 8.

FIG. 6 is a flow chart showing an example of the processing operation performed by a occlusion interpolator.

FIG. 7 is a diagram explaining how to interpolate a lacking pixel.

FIG. 8 is a diagram showing an example of a GUI screen displayed by a user interface.

FIG. 9A is a diagram showing an initial composite image before adjusting each slider.

FIG. 9B is a diagram showing a composite image generated by moving a vertical shooting position adjustment slider 31 upward.

FIG. 9C is a diagram showing a composite image generated by moving a horizontal shooting position adjustment slider 32 to the right.

FIG. 10 is a block diagram showing a schematic structure of the image processor 1 according to a second embodiment.

### DETAILED DESCRIPTION

An image processor according to one embodiment has an image acquisition unit to acquire a plurality of image data items obtained by imaging an identical subject and its background from different positions, a distance estimator to estimate a distance from a reference position to predetermined pixels in a common image included in all of the image data items, a threshold value determining unit to determine a threshold value of the distance to separate the common image into a foreground image including at least a part of the subject and a background image, a plurality of foreground/background separators to separate the common image in each of the image data items into the foreground image and the background image based on the threshold value, a plurality of image clipping units to generate a partial background image by clipping each of the image data items to include a part of the background image, a plurality of image enlargers to generate an enlarged partial background image from each of the image data items by enlarging the partial background image, a occlusion interpolator to generate an interpolated occlusion image by interpolating lacking pixels in an enlarged partial background image having the smallest number of pixels lacking due to the corresponding foreground image, and a composite image generator to generate a composite image based on the foreground image including at least a part of the subject and the interpolated occlusion image.

Embodiments will now be explained with reference to the accompanying drawings. In the following embodiments, characteristic components and operations in an image processor will be mainly explained, but the image processor may involve the components and operations which are omitted in the following explanation. Note that these omitted components and operations are included in the scope of the present embodiments.

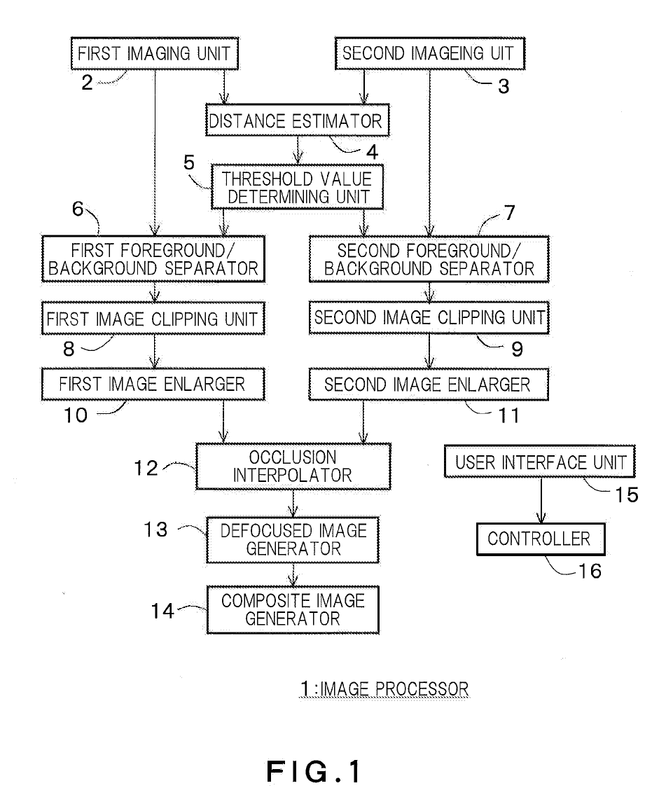

FIG. 1 is a block diagram showing a schematic structure of an image processor 1 according to an embodiment.

The image processor 1 of FIG. 1 has a first imaging unit 2 which images a first image to obtain first image data, a second imaging unit 3 which images a second image to obtain second image data, a distance estimator 4, a threshold value determining unit 5, a first foreground/background separator 6, a second foreground/background separator 7, a first image clipping unit 8, a second image clipping unit 9, a first image enlarger 10, a second image enlarger 11, a occlusion interpolator 12, a defocused background generator 13, a composite image generator 14, a user interface 15, and a controller 16.

The first imaging unit 2 and the second imaging unit 3 are installed at specific positions different from each other, and image the same subject and its background at the same timing from the respective positions. Each of the first imaging unit 2 and the second imaging unit 3 is a digital camera or an image sensor/module such as a CMOS sensor and a CCD (Charge Coupled Device), and its concrete configuration is not questioned.

Each of the first imaging unit 2 and the second imaging unit 3 may have a function of acquiring and storing the taken image data, or an image acquisition unit and an image storage (not shown) may be separately provided to acquire and store the image data taken by the imaging units 2 and 3. In the following explanation, each of the first imaging unit 2 and the second imaging unit 3 functions also as an image acquisition unit.

The distance estimator 4 estimates the distance from a reference position to predetermined pixels in a common image included both in the first image data and the second image data. The reference position is, e.g., the intermediate position between the installation location of the first imaging unit 2 and the installation location of the second imaging unit 3. The predetermined pixels can be each pixel, and can be a chosen pixels in the common image. Note that the distance estimator 4 previously grasps the installation locations of the first imaging unit 2 and the second imaging unit 3. Thus, the distance estimator 4 can also grasp the reference position previously. Note that whether the common image is included in the two image data items can be detected by a well-known technique such as pattern matching. Since the first imaging unit 2 and the second imaging unit 3 take the same subject and its background, the common image includes a subject image.

The distance estimator 4 estimates the distance from the reference position to each pixel in the common image included in the two image data items by using a stereo method, for example. The distance estimated by the distance estimator 4 is represented as a numerical value within a range of 0 to 255, for example.

Note that each of the first imaging unit 2 and the second imaging unit 3 may irradiate the subject with, e.g., laser light and receive the light reflected from the subject, to estimate the distance to the subject. When the reflected light is not received within a predetermined time, the image may be recognized as a background image. As stated above, the distance estimator 4 may estimate the distance through software processing using the stereo method etc., or through hardware having a light emitter and a light receiver.

The threshold value determining unit 5 determines a threshold value of the distance as a reference to separate the common image into a foreground image including the subject and a background image. How to determine the threshold value may be selected from a plurality of available techniques. For example, the following first to third techniques can be used as typical techniques to determine the threshold value.

In the first technique, the distances from the respective pixels estimated by the distance estimator 4 are averaged and the average value is determined as the threshold value.

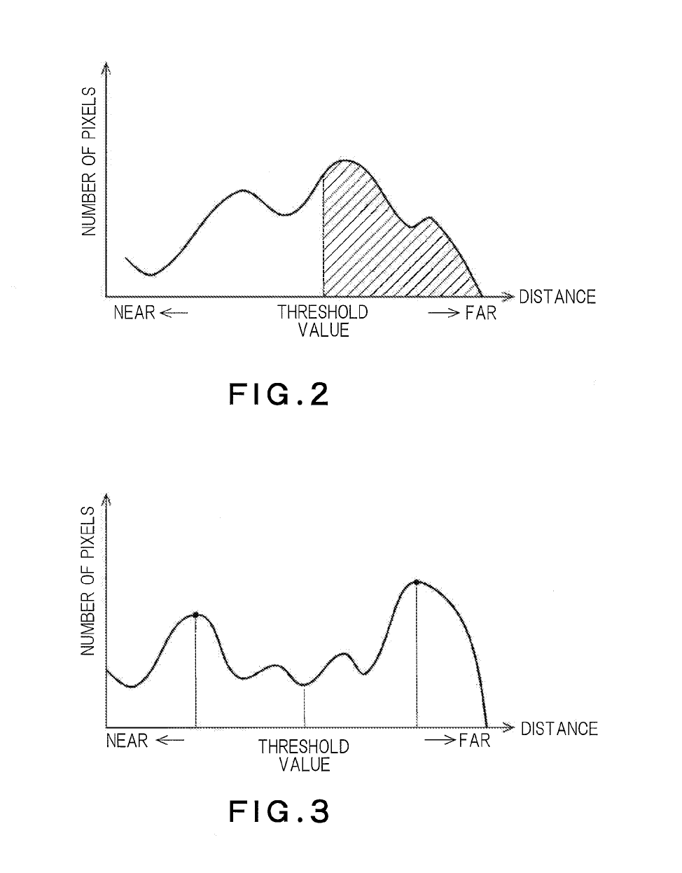

In the second technique, a histogram showing the distance to each pixel estimated by the distance estimator 4 is generated, and the distance corresponding to a predetermined ratio from the farthest position toward the nearer side in the common image is determined as the threshold value. FIG. 2 is a diagram explaining the second technique. In the histogram of FIG. 2, the horizontal axis represents the distance, and the vertical axis represents the number of pixels having the same distance. In the second technique, the distance when the ratio of histogram area from the farthest position to a certain point on the nearer side reaches a predetermined ratio (e.g., 40%) of the total histogram area is determined as the threshold value.

In the third technique, the average value of a plurality of distances at peak points in the histogram showing the distance to each pixel estimated by the distance estimator 4 is determined as the threshold value. FIG. 3 is a diagram explaining the third technique. In the histogram of FIG. 3, the peak points exist on the far side and the near side, respectively. Accordingly, the average value of the distances at these peak points is determined as the threshold value.

The first foreground/background separator 6 regards a pixel as the foreground when the distance to this pixel within the common image in the first image data is equal to or less than the threshold value, and regards a pixel as the background when the distance to this pixel is greater than the threshold value. Based on this, the first foreground/background separator 6 separates the common image in the first image data into a first foreground image and a first background image, and generates a first foreground mask image. The foreground mask image is an image overlapping the background image to express the foreground image with binary pixel values of 0 and 1. For example, in the foreground mask image, pixels corresponding to the position of the foreground image overlapping the background image have the value of 1, and the other pixels have the value of 0.

The second foreground/background separator 7 regards a pixel as the foreground when the distance to this pixel within the common image in the second image data is equal to or less than the threshold value, and regards a pixel as the background when the distance to this pixel is greater than the threshold value. Based on this, the second foreground/background separator 7 separates the common image in the second image data into a second foreground image and a second background image, and generates a second foreground mask image.

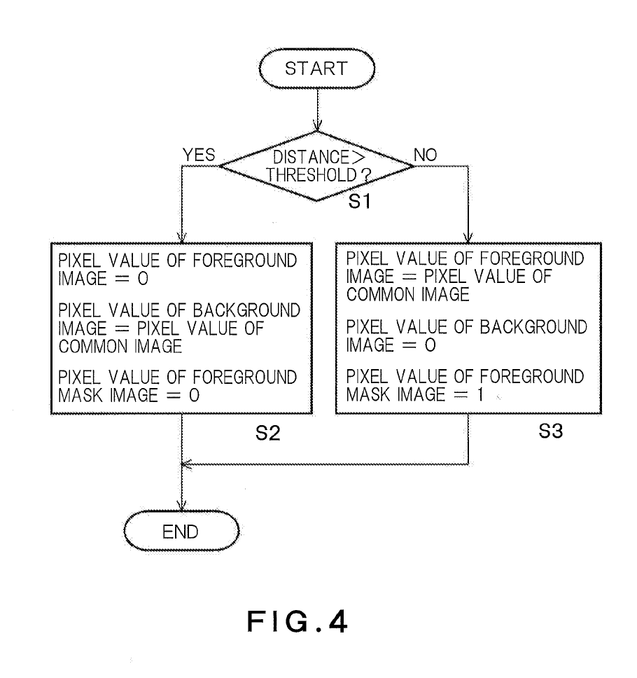

FIG. 4 is a flow chart showing an example of the processing operation performed by each of the first foreground/background separator 6 and the second foreground/background separator 7. This process is performed on each pixel in the common image after the distance to each pixel is estimated by the distance estimator 4. First, it is judged whether the distance to a target pixel is greater than the threshold value (S1). If the distance is judged to be greater than the threshold value (S1—YES), the pixel value of the target pixel in the foreground image is set to 0, the pixel value of the target pixel in the background image is set to the pixel value of the target pixel in the original common image, and the pixel value of the target pixel in the foreground mask image is set to 0 (S2). If the distance is judged to be equal to or less than the threshold value (S1—NO), the pixel value of the target pixel in the foreground image is set to the pixel value of the target pixel in the original common image, the pixel value of the target pixel in the background image is set to 0, and the pixel value of the target pixel in the foreground mask image is set to 1 (S3).

As stated above, in FIG. 4, the pixel value of a pixel is assigned to the background image when the distance to this pixel is greater than the threshold value, and the pixel value of a pixel is assigned to the foreground image when the distance to this pixel is equal to or less than the threshold value. Further, the foreground mask image has the pixel value of 1 only when the distance is equal to or less than the threshold value.

The first image clipping unit 8 generates a first partial background image by clipping a part of the first background image. The second image clipping unit 9 generates a second partial background image by clipping a part of a second background image. More concretely, each of the first image clipping unit 8 and the second image clipping unit 9 clips a part of the background image based on the information about clipping volume and clipping position transmitted from the controller 16. The clipping volume is expressed as “the size of the output image×(1/the enlargement ratio of the background image in the first image enlarger 10),” which shows the number of pixels in the longitudinal direction and the number of pixels in the lateral direction. The clipping position shows a coordinate value of a specific position (e.g., pixel at the upper left corner) in the background image.

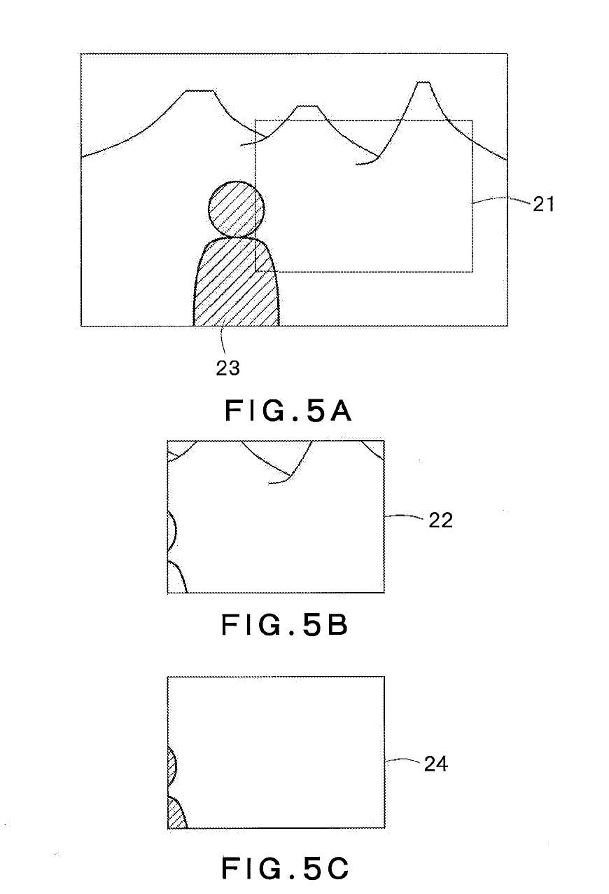

FIG. 5 is a diagram showing a concrete example of the clipping volume and clipping position in the first image clipping unit 8. In the example shown in FIG. 5, a rectangular area 21 in the background image is clipped, and the clipping position is set at the upper left corner of the rectangular area 21. When clipping the rectangular area 21 in the background image of FIG. 5A, a partial background image 22 of FIG. 5B is obtained. A hatched region 23 of FIG. 5A shows the foreground image (subject image), and pixel values of the partial background image 22 corresponding to the pixel positions of the foreground image overlapping the partial background image 22 of FIG. 5B are lacking.

Further, the first image clipping unit 8 and the second image clipping unit 9 generate first and second partial foreground mask images respectively, by clipping the rectangular area 21 from the foreground mask image with the same size and at the same position. FIG. 5C shows an example of clipping a partial foreground mask image 24 from FIG. 5A. As stated above, the partial foreground mask image 24 is an image expressing the pixels lacking in the partial background image 22 due to the foreground image, with binary values. In FIG. 5C, the pixels in the hatched part have the value of 1, and the pixels in the area excepting the hatched part have the value of 0.

The first image enlarger 10 generates a first enlarged partial background image and a first enlarged partial foreground mask image by enlarging the first partial background image and the first partial foreground mask image at a predetermined enlargement ratio.

Similarly, the second image enlarger 11 generates a second enlarged partial background image and a second enlarged partial foreground mask image by enlarging the second partial background image and the second partial foreground mask image at a predetermined enlargement ratio.

The occlusion interpolator 12 generates an interpolated occlusion image by interpolating the lacking pixels in an enlarged partial background image having the smallest number of pixels lacking due to the subject included in the first and second enlarged partial background images.

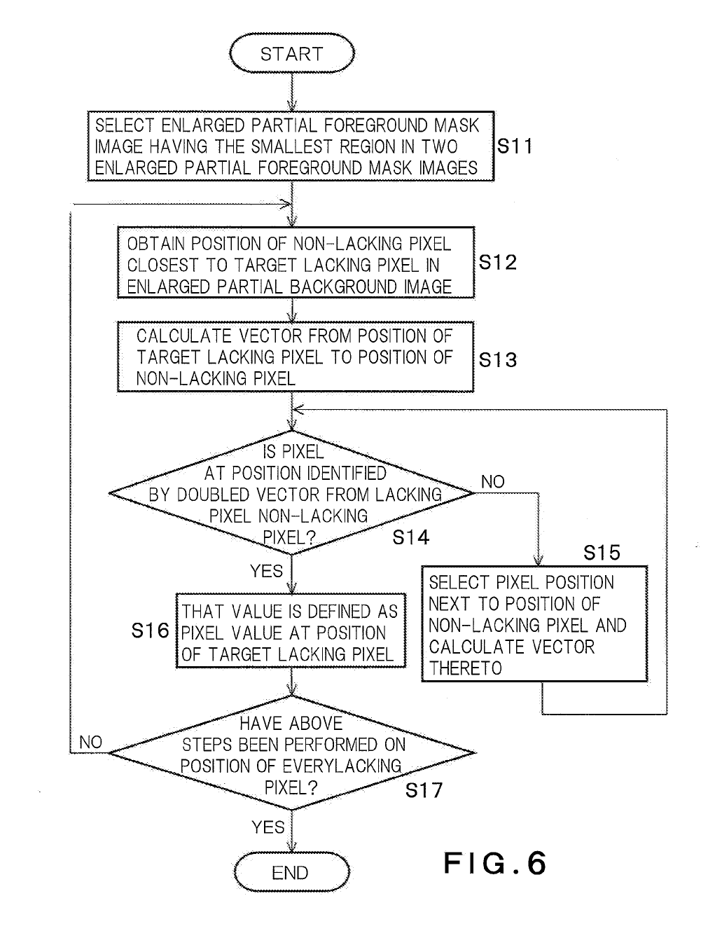

More specifically, the occlusion interpolator 12 generates the interpolated occlusion image based on the flow chart of FIG. 6.

First, the occlusion interpolator 12 selects an enlarged partial foreground mask image having the smallest mask region in the first and second enlarged partial foreground mask images (S11). Here, an enlarged partial foreground mask image having a smaller number of pixels having the pixel value of 1 is selected. Then, the enlarged partial background image corresponding to the selected enlarged partial foreground mask image is selected.

Next, the occlusion interpolator 12 interpolates the pixels lacking in the corresponding enlarged partial background image, the lacking pixels corresponding to the pixels having the pixel value of 1 in the selected enlarged partial foreground mask image.

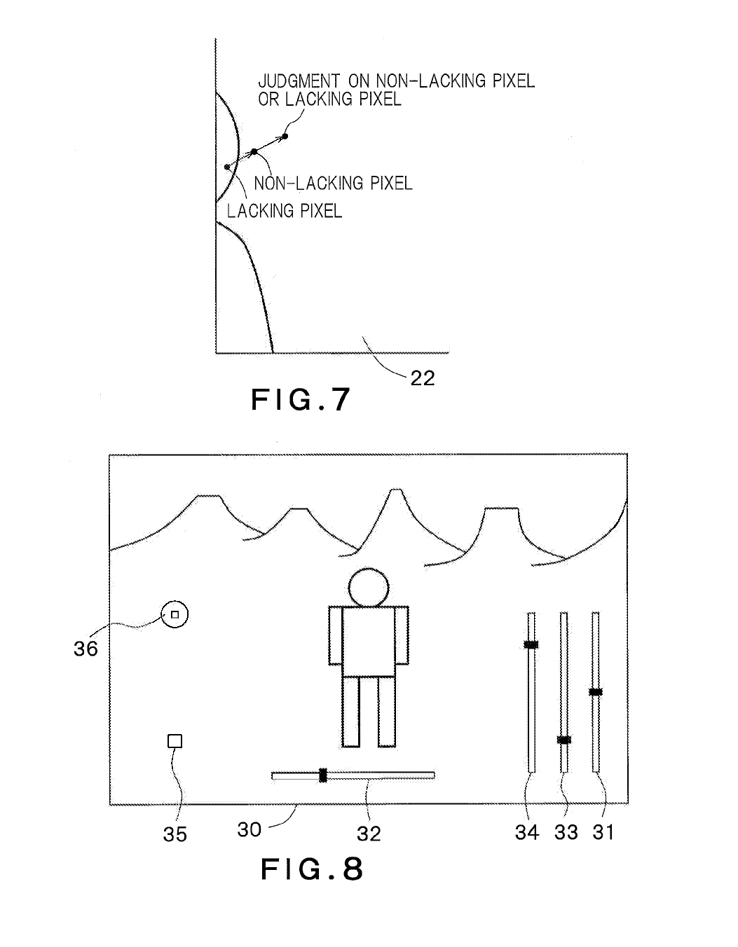

Concretely, first, the position of a non-lacking pixel closest to a target lacking pixel in the enlarged partial background image is obtained (S12). Next, a vector from the position of the target lacking pixel to the position of the obtained non-lacking pixel is calculated (S13). Next, as shown in FIG. 7, a vector which is twice the calculated vector is generated, and it is judged whether the pixel at the position identified by the doubled vector from the lacking pixel is a non-lacking pixel (S14). If the pixel is not a non-lacking pixel (S14—NO), the pixel position next to the position of the non-lacking pixel obtained at S12 is selected, a vector to this pixel position is calculated (S15), and the flow returns to S14.

If the pixel is judged to be a non-lacking pixel (S14—YES), its pixel value is defined as the pixel value at the position of the target lacking pixel (S16). The above steps are performed on the position of every lacking pixel (S17).

The defocused background generator 13 generates a defocused background image by defocusing the interpolated occlusion image based on a defocus amount received from the controller 16 and information about the distance estimated by the distance estimator 4.

More concretely, the defocused background generator 13 determines defocus intensity based on the value of distance to each pixel. For example, the defocused background generator 13 detects a difference between the distance estimated by the distance estimator 4 and the threshold value determined by the threshold value determining unit 5 with respect to each pixel in the interpolated occlusion image, to calculate the defocus intensity regarding this difference as the distance from the focus position. More concretely, a value obtained by dividing the detected difference by the difference between the threshold value and the maximum distance value in the respective pixels in the interpolated occlusion image is defined as a coefficient of additional defocus amount.

Next, based on the above defocus intensity, the defocused background generator 13 generates a defocused image by defocusing each pixel in the interpolated occlusion image depending on the distance thereto while using a technique of defocusing based on a lens PSF model or a Gaussian distribution.

The composite image generator 14 generates a composite image by synthesizing the foreground image including the subject and the defocused background image. At this time, each pixel in the defocused background image corresponding to a pixel having the pixel value of 0 in the enlarged partial foreground mask image has the pixel value of 0. This makes it possible to obtain a composite image which is adjusted in terms of the position of viewpoint and compression effect.

The user interface 15 sets how to determine the position of the foreground/background and adjusts compression effect, vertical shooting position, horizontal shooting position, and background defocus amount. The user interface 15 displays a GUI screen 30 as shown in FIG. 8 for example so that the user can set how to determine the position of the foreground/background and adjust compression effect, vertical shooting position, horizontal shooting position, and background defocus amount, on this GUI screen 30. Here, the adjustment of compression effect means adjusting the enlargement ratio of the background image.

More specifically, on the GUI screen 30 of FIG. 8, there are provided a vertical shooting position adjustment slider 31, a horizontal shooting position adjustment slider 32, a compression effect adjustment slider 33, a background defocus amount adjustment slider 34, a foreground/background position determination method setting button 35, and a shooting button 36. The user can operate the sliders 31 to 34 and buttons 35 and 36 using a pointing device such as a mouse and a touch sensor. The adjustment amount can be arbitrarily changed by changing the position indicated by each of the sliders 31 to 34.

The vertical shooting position adjustment slider 31 is provided to change a virtual shooting position in the upper/lower direction. The horizontal shooting position adjustment slider 32 is provided to change a virtual shooting position in the right/left direction. The compression effect adjustment slider 33 is provided to adjust the strength of the compression effect. The background defocus amount adjustment slider 34 is provided to adjust the defocus amount of the background. The foreground/background position determination method setting button 35 is provided to set how the threshold value determining unit 5 determines the threshold value. For example, when there are a plurality of techniques for determining the threshold value, buttons for selecting the respective techniques may be separately provided, or only one button may be provided so that the user can sequentially select a different technique each time the user pushes the button. The shooting button 36 is provided to instruct to generate a composite image based on the conditions selected by the respective sliders and buttons.

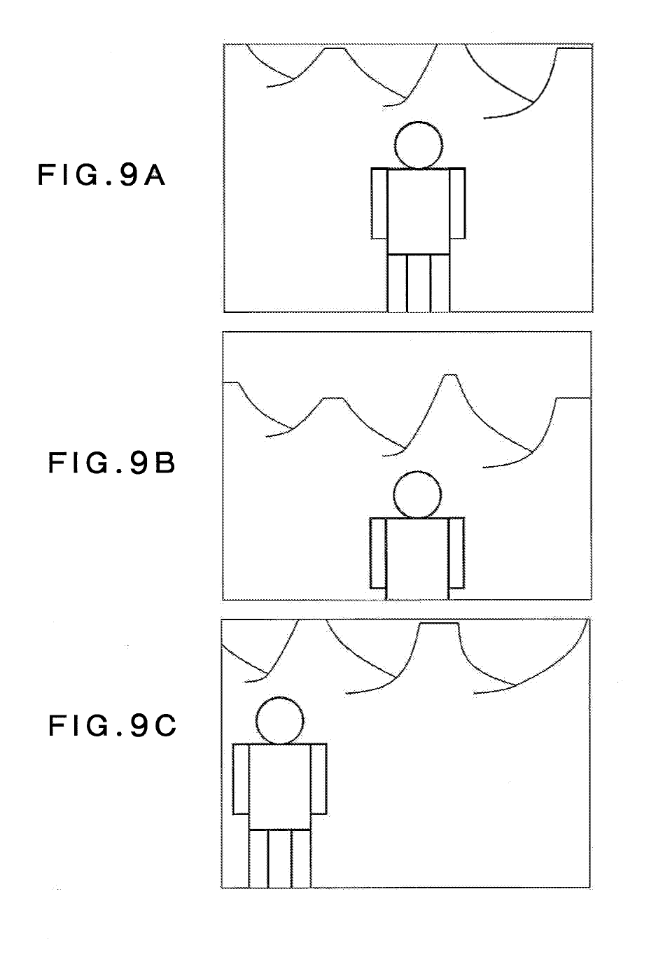

FIG. 9A is a diagram showing an initial composite image before adjusting each slider, FIG. 9B is a diagram showing a composite image generated by moving the vertical shooting position adjustment slider 31 upward, and FIG. 9C is a diagram showing a composite image generated by moving the horizontal shooting position adjustment slider 32 to the right.

As stated above, images once taken can be utilized to generate a composite image at an arbitrary shooting position and an arbitrary enlargement ratio, without taking images again with the first imaging unit 2 and the second imaging unit 3. Further, the vertical shooting position adjustment slider 31 and the horizontal shooting position adjustment slider 32 make it possible to adjust the position of the subject (foreground image) in the composite image. Furthermore, the background defocus amount adjustment slider 34 makes it possible to adjust the defocus amount of the background image in the composite image. Still further, the compression effect adjustment slider 33 makes it possible to adjust the enlargement ratio of the background image in the composite image.

Note that the GUI screen 30 generated by the user interface 15 should not be limited to FIG. 8, and various GUI screens are applicable. Further, instead of using the GUI screen 30, each adjustment may be performed through a controller having buttons operated by the user to perform the respective adjustments, or through the voice of the user utilizing voice recognition functions.

The controller 16 acquires various setting information obtained by the user interface 15, to control the threshold value determining unit 5, the first image clipping unit 8, the second image clipping unit 9, the first image enlarger 10, the second image enlarger 11, and the occlusion interpolator 12.

More concretely, the controller 16 determines how the threshold value determining unit 5 determines the threshold value, based on the operating information obtained by the foreground/background position determination method setting button 35. Further, the controller 16 sets the clipping position of the background image in each of the first image clipping unit 8 and second image clipping unit 9, based on the adjustment information obtained by the vertical shooting position adjustment slider 31 and the horizontal shooting position adjustment slider 32. The controller 16 also sets the clipping volume of the background image, based on the adjustment information obtained by the compression effect adjustment slider 33. Furthermore, the controller 16 sets the defocus amount in the defocused background generator 13, based on the adjustment information obtained by the background defocus amount adjustment slider 34. Still further, when the shooting button 36 is operated, the controller 16 stores, in a storage, the composite image generated by the composite image generator.

As stated above, in the first embodiment, a common image including a subject appearing in both of two image data items taken by the first imaging unit 2 and the second imaging unit 3 and a background of the subject is separated into a foreground image and a background image, and the background image is clipped with an arbitrary size and at an arbitrary position and then enlarged at an arbitrary enlargement ratio, in order that the clipped and enlarged background image and the foreground image are synthesized to generate a composite image. Therefore, even when the distance between the subject and each of the first imaging unit 2 and the second imaging unit 3 is not long enough, it is possible to generate a composite image in which the foreground image including the subject is further emphasized. In particular, since the background image can be defocused with an arbitrary defocus amount, it is possible to obtain such an effect as obtained when shooting the subject using a telephoto lens with a sufficient distance therebetween.

Further, since the position of the subject in the background image, the enlargement ratio of the background image, etc. can be adjusted by the user interface 15, the user can generate a composite image including the subject and its background at an arbitrary field angle, without taking an image again. As stated above, according to the present embodiment, a plurality of composite images having different compression effects can be generated by effectively utilizing the image data once taken.

In the first embodiment, the defocused background generator 13 performs the defocusing process after the interpolated occlusion image is generated, but defocusing the background image is not necessarily essential and thus may be omitted. This is similarly applied to the other embodiments to be explained below.

### Second Embodiment

In the example explained in the first embodiment, a composite image is generated using two image data items taken by the first imaging unit 2 and the second imaging unit 3 provided in the image processor 1, but the first imaging unit 2 and the second imaging unit 3 are not essential.

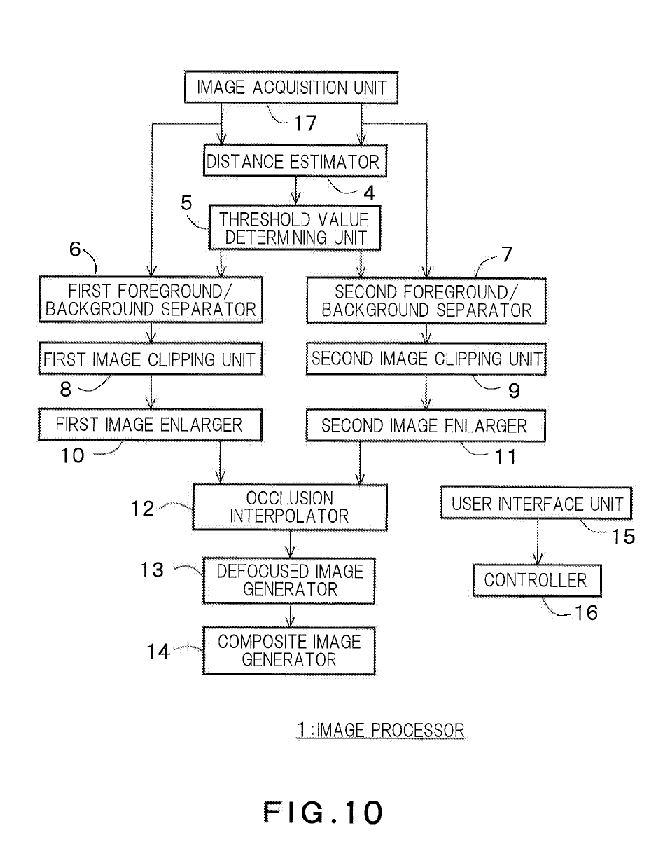

FIG. 10 is a block diagram showing a schematic structure of the image processor 1 according to a second embodiment. The image processor 1 of FIG. 10 has an image acquisition unit 17 instead of the first imaging unit 2 and the second imaging unit 3 of FIG. 1. The image acquisition unit 17 acquires two image data items taken by one or more imaging devices (not shown) provided separately from the image processor 1. The two image data items are obtained by shooting the same subject and its background from different shooting directions and at different field angles, and include a common image including the subject. The installation locations of the imaging devices at the time of shooting are previously known or estimated by, e.g., a camera position estimating technique for estimating the shooting position of the image using a plurality of image data items, or the positions at the timing of acquiring two images are estimated by an acceleration sensor, which means that the positional relationship between the images is previously grasped. Similarly to the first embodiment, the distance estimator 4 estimates the distance to each pixel in the common image, based on two image data items and such position information. The processing operations performed by the components following the distance estimator 4 are similar to the first embodiment.

Although omitted in FIG. 10, an image storage for storing the image data acquired by the image acquisition unit 17 may be provided in or separately from the image acquisition unit 17. For example, when the image storage stores two or more image data items including the same subject and its background, the image acquisition unit 17 may acquire arbitrary two image data items from the image storage to generate a composite image.

As stated above, in the second embodiment, the image processor 1 having no imaging device acquires two image data items to generate a composite image, which simplifies hardware configuration of the image processor 1 and makes it possible to effectively utilize the image data already taken to generate an arbitrary composite image emphasizing the subject.

### Third Embodiment

In the examples explained in the first and second embodiments, a composite image is generated using two image data items, but the composite image may be generated using three or more image data items. For example, when using n image data items (n is an integer of 3 or greater), the foreground/background separator, image clipping unit, and image enlarger are provided for each image data item. Steps to be performed until an enlarged partial background image and an enlarged partial foreground mask image are generated from each of n image data items are similar to the first embodiment.

First, the occlusion interpolator 12 selects an enlarged partial foreground mask image having the smallest number of mask pixels (pixels having the pixel value of 1) in n enlarged partial foreground mask images, and selects an enlarged partial background image corresponding thereto.

Next, when an enlarged partial foreground mask image includes a pixel which has the pixel value of 0 and corresponds to a lacking pixel (pixel having the pixel value of 1) in the selected enlarged partial foreground mask image, the pixel value of the lacking pixel is interpolated using the enlarged partial background image corresponding to this enlarged partial foreground mask image. A concrete technique of interpolation is similar to that used by the occlusion interpolator 12 in the first embodiment.

As stated above, in the third embodiment, a composite image is generated using three or more image data items, which makes it possible to interpolate the lacking pixels in the enlarged partial background image with high accuracy.

At least a part of the image processor 1 in the above embodiments may be formed of hardware or software. In the case of software, a program realizing at least a partial function of the image processor 1 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the image processor 1 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An image processor comprising:
an image acquisition unit to acquire a plurality of image data obtained by imaging an identical subject and its background from different positions;
a distance estimator to estimate a distance from a reference position to predetermined pixels in a common image included in all of the image data;
a threshold value determining unit to determine a threshold value of the distance to separate the common image into a foreground image including at least a part of the subject and a background image;
a foreground/background separator to separate the common image in each of the image data into the foreground image and the background image based on the threshold value;
a image clipping unit to generate a partial background image by clipping each of the image data to include a part of the background image;
a image enlarger to generate an enlarged partial background image from each of the image data by enlarging the partial background image;
a occlusion interpolator to generate an interpolated occlusion image by interpolating lacking pixels in an enlarged partial background image having the smallest number of pixels lacking due to the corresponding foreground image; and
a composite image generator to generate a composite image based on the foreground image and the interpolated occlusion image.

2. The image processor of claim 1, further comprising a user interface to set at least one of: how the threshold value determining unit determines the threshold value; a clipping position of the corresponding background image in the image clipping unit; and an enlargement ratio of the corresponding partial background image in the image enlarger.

3. The image processor of claim 1, further comprising a defocused background generator to generate a defocused background image by defocusing the interpolated occlusion image,
wherein the composite image generator generates the composite image based on the defocused background image and the foreground image.

4. The image processor of claim 3, wherein the defocused background generator determines a defocus intensity representing the strength of defocus based on the distance to each pixel in the interpolated occlusion image, and generates the defocused background image based on the defocus intensity.

5. The image processor of claim 4, further comprising a user interface to set at least one of: how the threshold value determining unit determines the threshold value; a clipping position of the corresponding background image in the image clipping unit; an enlargement ratio of the corresponding partial background image in the image enlarger; and a defocus amount of the defocused background image generated by the defocused background generator.

6. The image processor of claim 1, further comprising a plurality of imaging devices to image an identical subject and its background from different positions,
wherein the image acquisition unit acquires the image data items imaged by the imaging devices.

7. The image processor of claim 6, further comprising an image storage to store the image data items imaged by the imaging devices,
wherein the image acquisition unit acquires the image data stored in the image storage.

8. The image processor of claim 1, wherein the threshold value determining unit determines that the threshold value is an average value of the distances from the respective pixels included in the common image.

9. The image processor of claim 1, wherein the threshold value determining unit sorts the distances from the respective pixels included in the common image in order of size, and determines that the threshold value is the distance corresponding to a predetermined ratio from the maximum distance.

10. The image processor of claim 1, wherein the threshold value determining unit generates a histogram defining the distance to each pixel included in the common image as the horizontal axis and defining the number of pixels having an identical distance as the vertical axis, and determines that the threshold value is a distance corresponding to an average value of a plurality of peak values in the histogram.

11. The image processor of claim 1, wherein the foreground/background separator generates, from the common image in each of the corresponding image data, the background image, the foreground image, and a foreground mask image overlapping the background image corresponding to positions of pixels in the foreground image, based on the threshold value.

12. The image processor of claim 11, wherein the image clipping unit generates the corresponding partial background image, and the partial foreground mask image which is obtained by clipping a part of the corresponding foreground mask image with an identical size and at an identical position as the partial background image.

13. The image processor of claim 12, wherein the image enlarger generates the corresponding enlarged partial background image, and an enlarged partial foreground mask image which is obtained by enlarging the corresponding partial foreground mask image with an identical enlargement ratio as the corresponding partial background image.

14. The image processor of claim 13, wherein the occlusion interpolator selects the enlarged partial background image corresponding to an enlarged partial foreground mask image which overlaps the foreground image least in the enlarged partial foreground mask images, and generates the interpolated occlusion image by interpolating the lacking pixel overlapping the foreground image in the selected enlarged partial background image using a value of another pixel in the selected enlarged partial background image.

15. The image processor of claim 13, wherein the occlusion interpolator selects the enlarged partial background image corresponding to an enlarged partial foreground mask image which overlaps the background image least in the enlarged partial foreground mask images, and generates the interpolated occlusion image by interpolating the lacking pixel overlapping the foreground image in the selected enlarged partial background image based on another enlarged partial background image which was not selected.

16. An image processing method comprising:
acquiring a plurality of image data obtained by imaging an identical subject and its background from different positions;
estimating a distance from a reference position to predetermined pixels in a common image included in all of the image data;
determining a threshold value of the distance as a reference to separate the common image into a foreground image including at least a part of the subject and a background image;
separating the common image in each of the image data into the foreground image and the background image based on the threshold value;
generating a partial background image by clipping each of the image data to include a part of the corresponding background image;
generating an enlarged partial background image from each of the image data by enlarging the corresponding partial background image;
generating an interpolated occlusion image by interpolating lacking pixels in an enlarged partial background image having the smallest number of pixels lacking due to the foreground image in the enlarged partial background images generated by the image enlargers; and
generating a composite image based on the foreground image and the interpolated occlusion image.

17. The image processing method of claim 16, further comprising:
setting at least one of: how to determine the threshold value in the step of determining the threshold value; a clipping position of the corresponding background image in the step of generating the partial background image; and an enlargement ratio of the corresponding partial background image in the step of generating the enlarged partial background image.

18. The image processing method of claim 16, further comprising:
generating a defocused background image by defocusing the interpolated occlusion image,
wherein the step of generating the composite image is provided to generate the composite image based on the defocused background image and the foreground image.

19. The image processing method of claim 16, wherein the separating generates, from the common image in each of the image data, the background image, the foreground image, and a foreground mask image overlapping the background image to show positions of pixels in the foreground image, based on the threshold value.
